(19) United States
(12) Patent Application Publication
(10) Pub. No.: US 2008/0234045 A1
(43) Pub. Date: Sep. 25, 2008

(54) GAMING SYSTEM AND METHOD OF GAMING

(75) Inventor: Brett Mezen, Holsworthy (AU)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty, Ltd., Lane Cove (AU)

(21) Appl. No.: 12/050,602

(22) Filed: Mar. 18, 2008

(30) Foreign Application Priority Data
Mar. 21, 2007 (AU) 2007901487

(51) Int. Cl. A63F 13/00

(52) U.S. Cl. 463/37

(57) ABSTRACT

Certain embodiments provide a gaming system including a touch screen display and a display controller arranged to control the touch screen display to display at least one player moveable object to a player of a game. The gaming system also includes a contact monitor arranged to monitor an output of the touch screen display to determine that a contact has been detected by the touch screen display at a first position corresponding to the current location of a moveable object and that the contact has been maintained with the touch screen display while moving to a second position. The display controller is further configured to control the display to display the moveable object at a new location derived from the second position.

### CROSS-REFERENCE TO RELATED APPLICATIONS

This application claims priority to Australian Provisional Patent Application No. 2007901487, having an international filing date of Mar. 21, 2007, entitled “Gaming System and Method of Gaming,” which is hereby incorporated by reference herein in its entirety.

### FIELD

The present invention relates to a gaming system and method of gaming.

### BACKGROUND

Known gaming machines enable a player to make selections in a game by pressing a button or touching a screen to indicate a selection chosen from discrete objects. This can limit the number of available selections to the number of available buttons.

### SUMMARY OF THE INVENTION

In a first aspect of the invention there is disclosed a gaming system comprising:
a touch screen display;
a display controller arranged to control the touch screen display to display at least one player moveable object to a player of a game; and
a contact monitor arranged to monitor an output of the touch screen display to determine that a contact has been detected by the touch screen display at a first position corresponding to the current location of a moveable object and that the contact has been maintained with the touch screen display while moving to a second position,
the display controller further configured to control the display to display the moveable object at a new location derived from the second position.

In an embodiment, the display controller controls the display to display the moveable object moving to the new location.

In an embodiment, a set of possible locations is defined for the moveable object, and the display controller derives the new location by determining which of the set of possible locations is nearest to the second position.

In an embodiment, the gaming system comprises a game outcome determiner arranged to determine a game outcome based on the new location of the moveable object.

In an embodiment, the at least one moveable object is an indicator, for example on a gauge or dial.

In an embodiment the indicator indicates a bet amount. In an embodiment, the indicator indicates a number of lines to be wagered on. In an embodiment, the indicator indicates a number of ways to be wagered on.

In an embodiment, there are a plurality of possible new locations, and the display controller moves the at least one moveable object to one of the possible new locations.

In an embodiment, there are a plurality of moveable objects.

In an embodiment, the game outcome determiner is arranged to determine a game outcome based on the new location of the moveable objects only after a specified number of the plurality of the moveable objects have moved to respective ones of a plurality of new locations.

In an embodiment, the game outcome determiner is arranged to determine that a condition has been met before determining a game outcome. For example, in one embodiment, the moveable object is a token indicating a position in a maze and a condition may be that a player reaches a specified position in the maze such as a position marked by a symbol, the end of the maze, or a “dead end”.

In this embodiment, a player may be allowed to release the moveable object as many times as desired until the condition is met.

In a second aspect of the invention there is disclosed a method of gaming comprising:
displaying at least one moveable object on a touch screen display;
monitoring an output of the touch screen display to determine that a contact has been detected by the touch screen display at a first position corresponding to the current location of the moveable object and that the contact is maintained with the touch screen display while moving to a second position; and
displaying the moveable object at a new location derived from the second position.

In an embodiment, the method comprises displaying the moveable object moving to the second position.

In a third aspect the invention provides a method of moving a moveable object in a gaming system:
contacting a touch screen display at a first position corresponding to the current location of the moveable object; and
maintaining contact to a second position corresponding to a desired new location of the moveable object.

In a fourth aspect the invention provides computer program code which when executed causes a computer to carry out the steps of:
displaying at least one moveable object on a touch screen display;
monitoring an output of the touch screen display to determine that a contact has been detected by the touch screen display at a first position corresponding to the current location of the moveable object and that the contact is maintained with the touch screen display while moving to a second position; and
displaying the moveable object at a new location derived from the second position.

### BRIEF DESCRIPTION OF THE DRAWINGS

Certain embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a schematic diagram of a networked gaming system;

FIG. 6 is a further block diagram of a gaming system;

FIG. 7 is a flowchart of an embodiment of the invention;

FIG. 8 is a perspective view of a gaming machine of a first example;

FIG. 9 is an exemplary display of a second example;

FIG. 10A to 10C show exemplary displays of a third example; and

FIGS. 11A to 11C show exemplary displays of a fourth example.

### DETAILED DESCRIPTION

Referring to the drawings, there is shown a gaming system arranged to permit a player to move objects during a game to variable locations. Gaming machines of the embodiment employ a touch screen display and allow a player to move an object by maintaining continuous contact with the screen. This can allow a player to move objects without requiring buttons corresponding to all of the possible outcomes or enable the player to have a sensation of greater tactile interaction with objects in the game.

General Description of Gaming System

The gaming system can take a number of forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

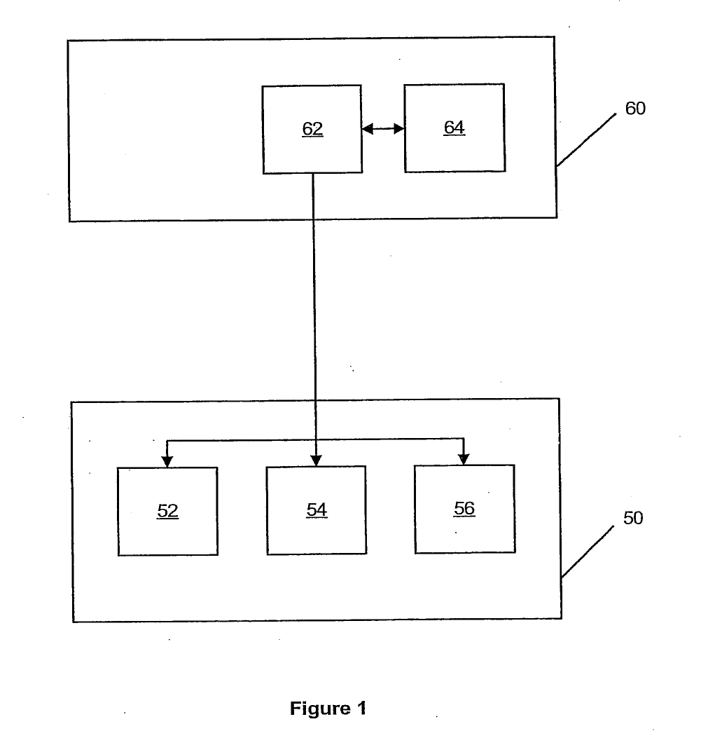

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions, in particular for the player to input a wager.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

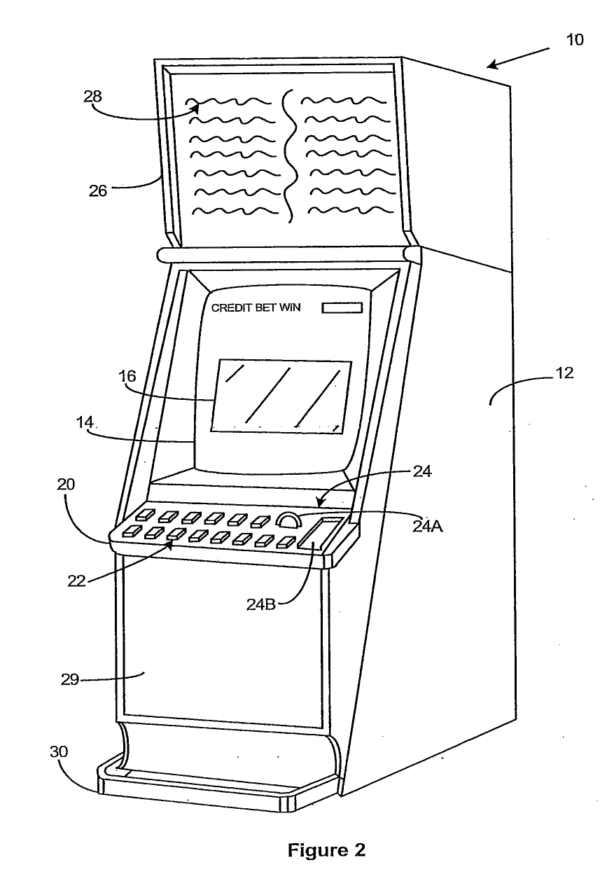

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during gameplay. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. Displays of the embodiment are fitted with a touch screen. The top box 26 may also include a display, for example a video display unit, which may be of the same type as the display 14, or of a different type.

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

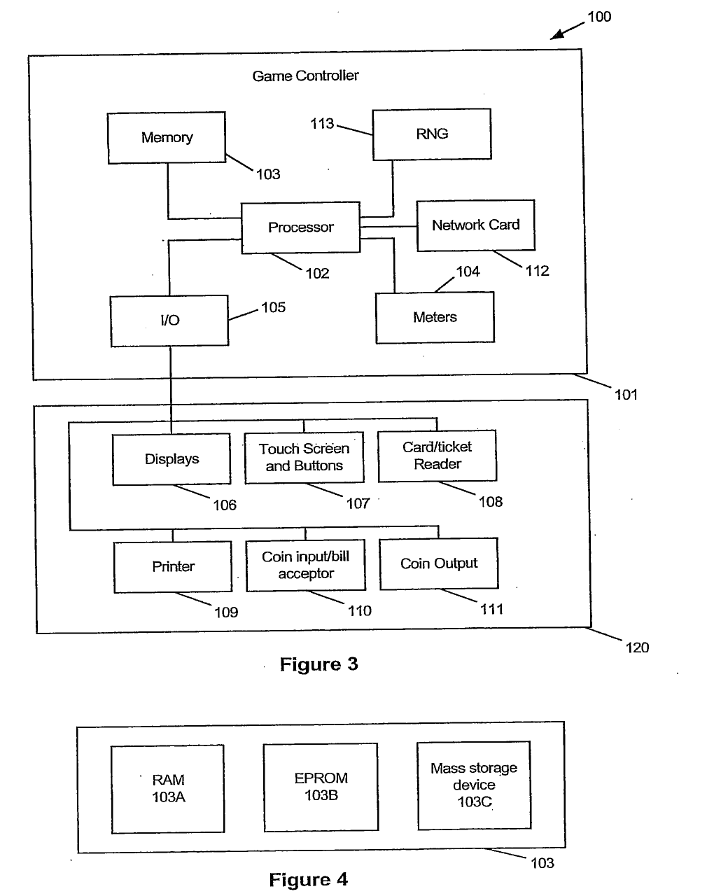

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

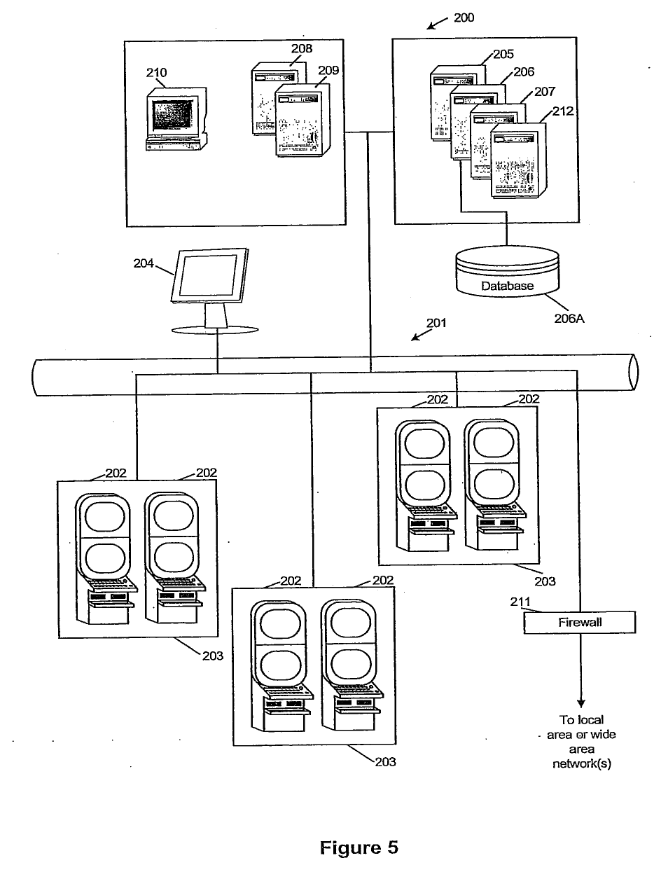

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to carry out at least the accounting functions of the Jackpot. A loyalty system 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

Further Detail of Gaming System

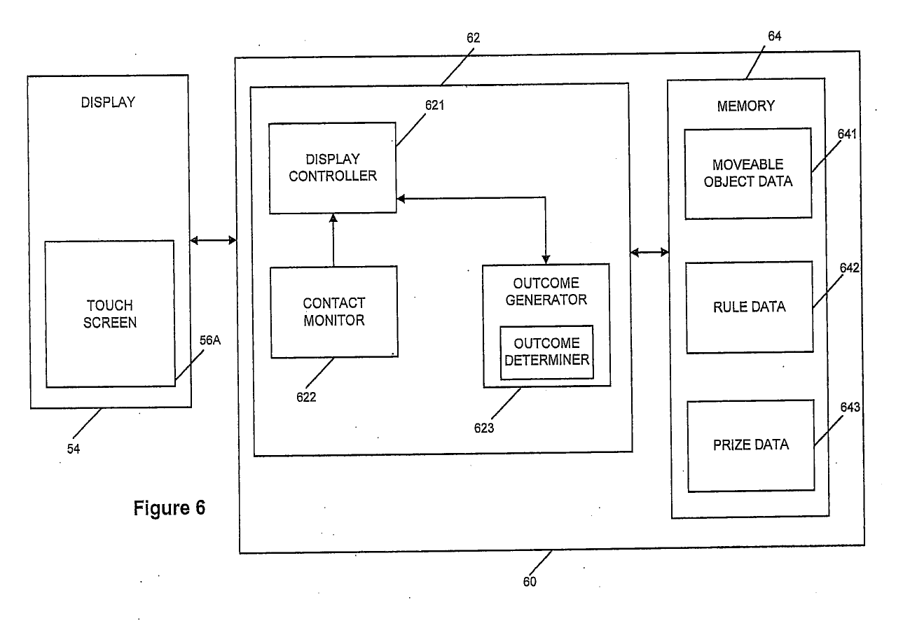

A gaming system is shown in more detail in FIG. 6. As shown in FIG. 6, display 54 includes a touch screen 56A to thereby provide a touch screen display. As shown in FIG. 3, various modules 621,622,623 are implemented by processor 62 executing code stored in memory 64. Other implementations, such as dedicated circuits, are possible.

The game controller 60 comprises a display controller 621 which controls the display on the basis of display data 641 to display at least one player moveable object to a player of a game. A contact monitor 622 is arranged to monitor the output of the touch screen 56A to determine that a contact has been detected by the touch screen display at a first position and that the contact has been maintained to a second position.

Contact monitor 622 provides data describing the second position to the display controller 621 which determines a new location for the moveable object from the second position data and controls the display to display the moveable object at the new location. In the embodiment the display controller 621 controls the display so that the object moves along a trajectory from the current position to the new position, the trajectory being defined by the maintained contact.

The new location can be derived from the second position in a number of different ways. For example, it can correspond exactly to the new position or it can be the closest of a set of available positions specified by moveable object data 641.

In an embodiment wherein movement of the movable object to the second location has an effect on game outcomes, the display controller 621 sends data to the outcome generator 623 specifying the new location of the object. When the outcome determiner 623A of outcome generator 623 is ready to determine the outcome of the game, the outcome determiner 623A determines the game outcome based on rule data 642 and the final new location of the moveable object. If a prize corresponds to the game outcome, the outcome generator 623 generates a prize based on prize data 643. In most embodiments, outcome generator 623 generates part of a game outcome based on rule data 642 prior to operation of the outcome determiner 623A. For example, if the game outcome includes some form of random selection to which the movement of the moveable object is applied, the random outcome is generate under control of the game outcome generator 623.

It will be appreciated that the outcome determiner 623A may evaluate the game outcome in a number of different ways. In one example, the outcome determiner 623A is arranged to receive a player instruction via the player interface 56A that indicates the player wishes the outcome generator 623 to evaluate a game outcome. In another embodiment, the outcome generator 623 determines that the movement of the object to the new position meets a condition specified in the rule data 642 for evaluation of the game outcome. Example conditions are that the object has been moved to a specified position, the object has been moved a specified number of times, or in the case where there are a plurality of moveable objects, that a specified number of moveable objects have been moved.

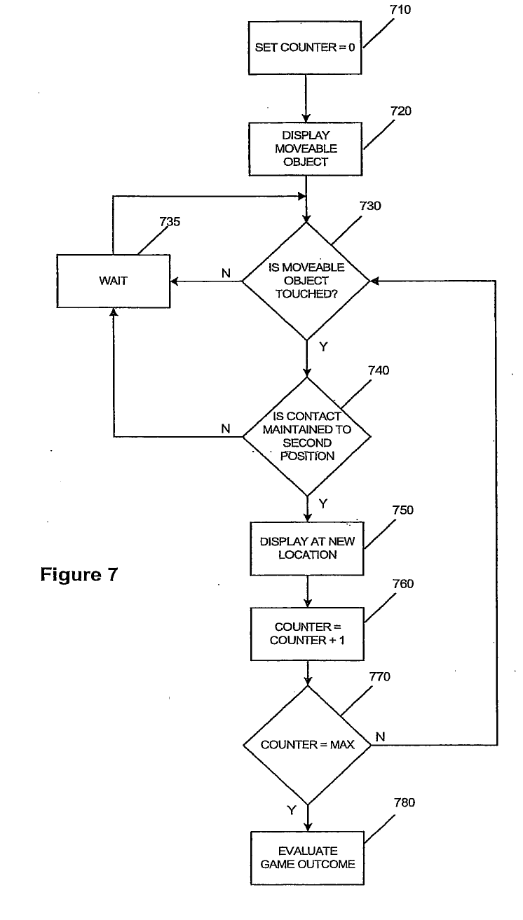

The flow chart of FIG. 7 corresponds to the two latter possibilities. At step 710 a counter is set to zero after the game begins. The counter can be used to monitor either the number of times that an object is moved or the number of objects that are moved. At 720 the number of moveable objects are displayed. At step 730 the game determines whether a moveable object has been touched. If the answer is “No” the game waits 735. If the answer is “Yes” the method involves determining whether contact is maintained for the duration of movement from the first position to a second position 740. If the answer is “No” the gaming machine waits 735 as the object is not being moved. If the answer is “Yes” the display controller displays the object at the new location 750 and the counter is incremented 760. At step 770 it is determined whether the counter has reached a maximum. If the answer is “No” the method reverts to step 730 to determine whether the moveable object is touched. If the answer is “Yes” and the maximum number of objects or the maximum number of moves has been made, the game outcome is evaluated at step 780 by the game outcome determiner 623A.

The embodiment allows a player to “drag and drop” an object which enables the player to make complex or multifaceted decisions in a simple move. This is faster and enables greater variety in selection than available one pick decision.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

A person skilled in the art will appreciate the various modifications may be made to the invention without departing from the scope of the invention described herein, some variations will be apparent from the following examples.

### EXAMPLE 1

### Open the Safe

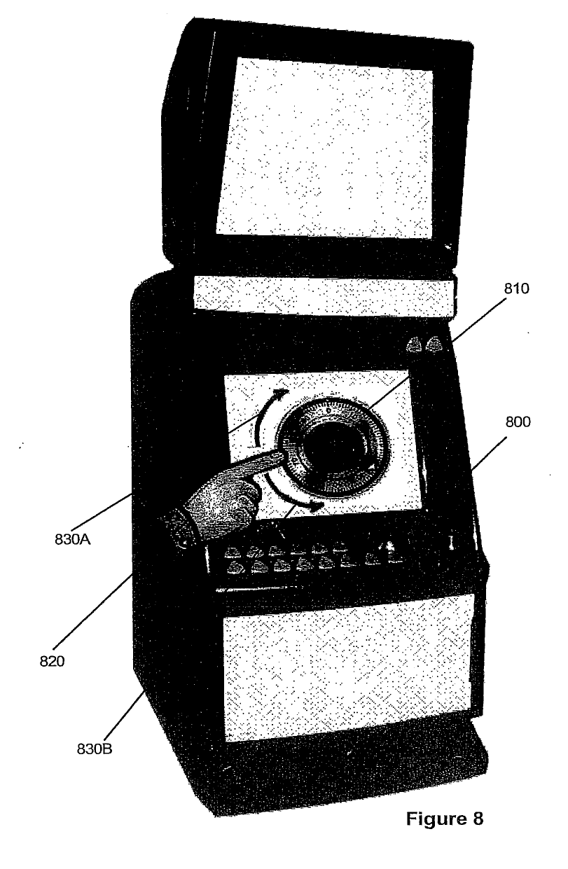

Referring to FIG. 8, in this game the player enters a feature of a gaming machine 800 and is asked to touch the screen and move an indicator on a dial 810 to a position which will open a safe. The stopping position which corresponds to opening the safe can be store as rule data 642 or generated, for example, randomly under control of outcome generator 623.

The player, as represented by hand 820, moves the indicator to any position from 0 to 99. The movement is made by rotating the indicator on the touch screen either clockwise 830A or anticlockwise 830B by maintaining contact with the touch screen until the visual image shifts to the desired stopping position. This has an advantage of simulating a turning motion. Further a large number of buttons to enable one hundred selections to be made is not required.

### EXAMPLE 2

### Choose the Bet

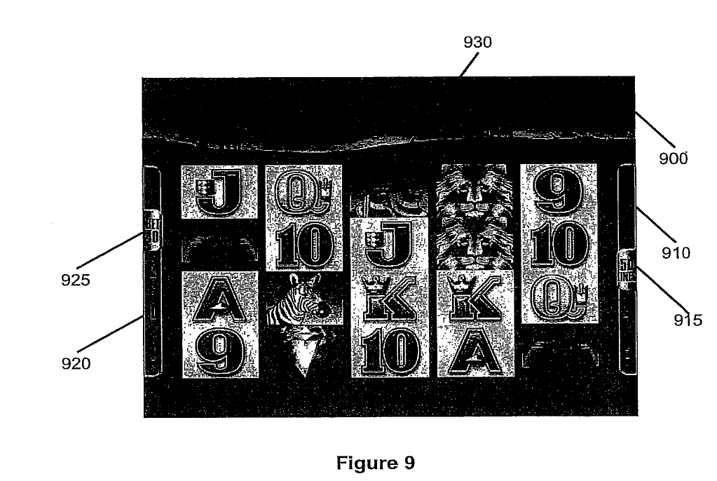

FIG. 9 shows an exemplary display 900 of a spinning reel 930 type game. In this example, the player selects the amount to be bet by sliding an object in the form of an indicator 925 up and down a scale 920 until the desired bet amount has been identified. The same process is used to allow the player to move an indicator 915 to select the number of lines 910 the player wishes to play. The bet amount and number of lines specify the player's wager. Once the wager has been made, the outcome generator 323, selects stopping positions for each reel using a random number generator. Outcome determiner 623A then evaluates the outcome based on prize data and the wager to determine whether to make an award to the player. If an award is made, the credit and win meters are updated.

In prior art, the setting of the bet or lines would have been made by using the touch screen or physical buttons to increase and decrease bets by repeated touching of the buttons which increment or decrement the bets. This has the disadvantage of requiring repeated hits by the player which can be irritating.

An alternative implementation in the prior art would have required the player to press one button which was labelled with a defined bet amount. This has the disadvantage of limiting choices to the number of buttons which can physically fit onto a space.

Persons skilled in the art will appreciate that this example can be extended to operating a slider to buy a number of “ways” in a game where win lines are provided by all combinations of row and column positions as disclosed in AU 684233.

### EXAMPLE 3

### Match the Hat

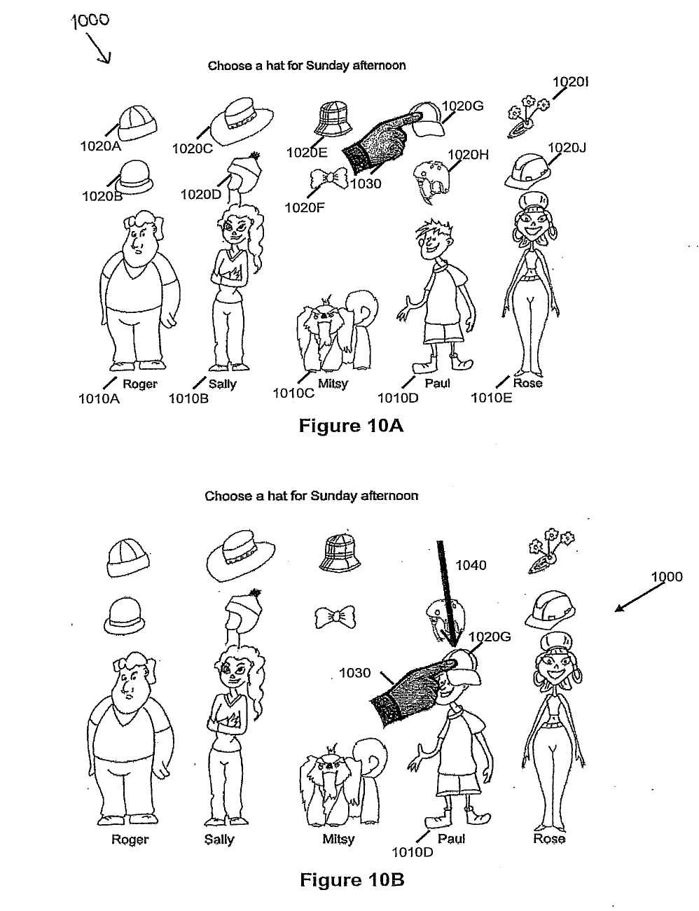

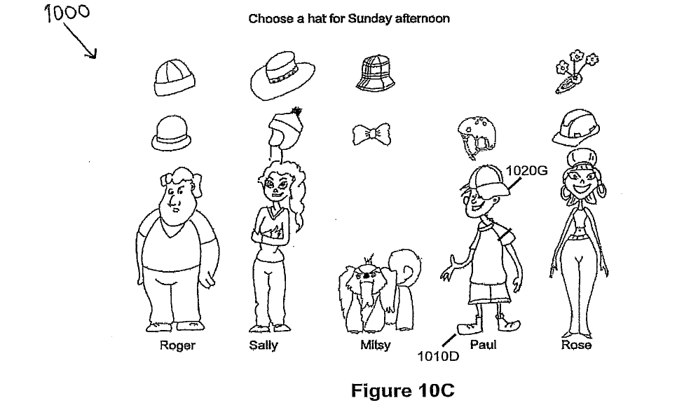

Referring to FIGS. 10A to 10C there are shown exemplary displays 1000 of a matching game. In this selection method, the player is offered the opportunity to match various hats 1020 with various bodies 1010. The player as represented by hand 1030 moves the hats 1020 to the different bodies 1010 by dragging each hat to the desired body. The player is given a choice of ten hats 1020 and five bodies 1010 and is asked to dress each body with a hat. The prize paid in the feature is evaluated by comparing the hat/body combinations selected by the player against criteria already set down in the game software.

The first arrangement is shown in FIG. 10A which shows all of the available hats and 1020 and bodies 1010. The player selects a moveable object in the form of hat 1020G as indicated by hand 1030. As shown by line 1040 in FIG. 10B, the player drags hat 1020G onto the head of body 1010D by moving their finger across the screen while maintaining contact with the screen. The machine is arranged so that once the hat 1020G is close enough to the body 1010, the hat will “snap” to the correct position on the body and the display is altered to show the new location.

The final location is shown in FIG. 10C. The game requires the players to make selection of each of the hats for each body until all bodies have a hat. Once all bodies have a hat 1020 the outcome determiner 623A will determine the game outcome based on the game rules.

In the prior art, matching several objects with other objects would have been very time consuming as each object to be moved would have required a button to be pressed to indicate which object to move, followed by pressing a button (touch screen or physical) for the object to be moved to. This example reduces the time taken for finalising selections and is more intuitive.

### EXAMPLE 4

### Maze

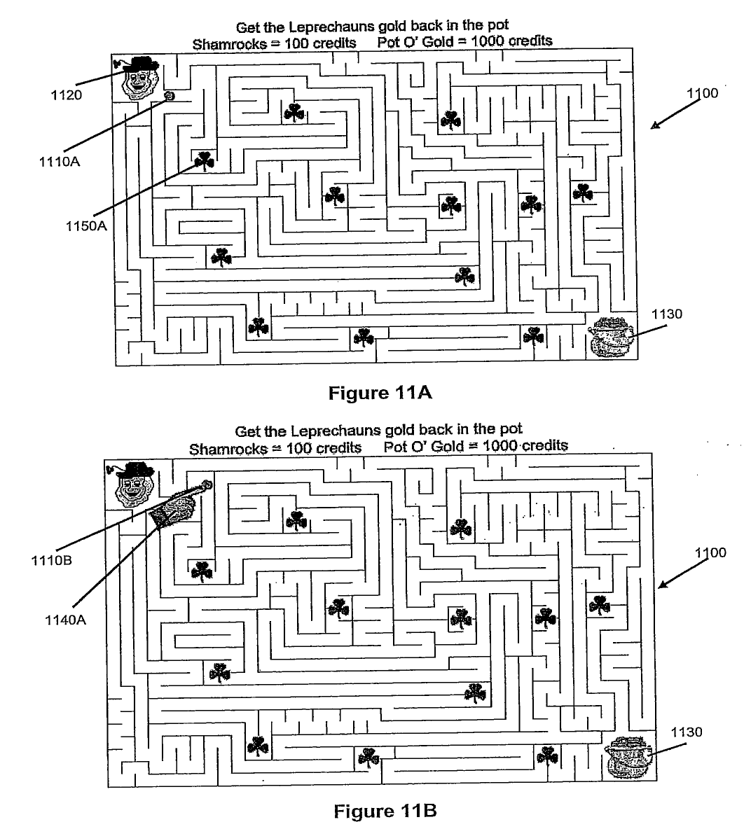

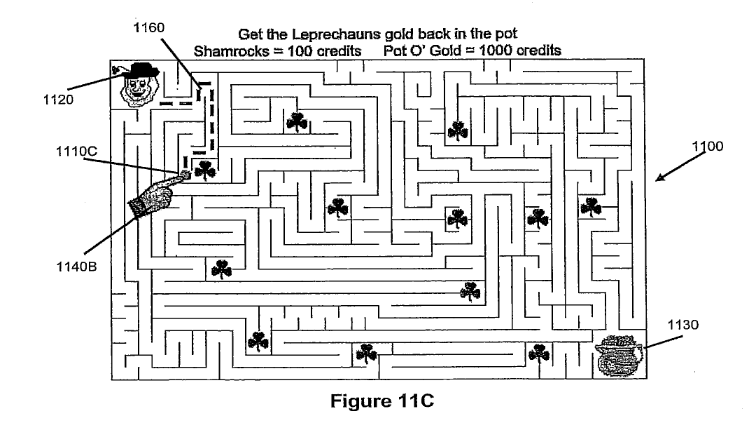

Referring to FIG. 11, in this style of game, the player as represented by hand 114 is asked to select a pathway through a maze. The player is shown the maze and then must draw their finger along a pathway to indicate which pathway they are choosing.

A person skilled in the art will appreciate that rather than a finger, the player may be provided with a stylus or similar to touch the screen. In the maze game, the intention for the player is to move along a path from a starting point represented by an image of a leprechaun 1120 on the exemplary display 1100 to an end point where there is a pot of gold 1130. The player wins a thousand credits for getting to the end point and a hundred credits for any of the displayed shamrocks 1150 the player encounters on the path. The game rules specify that the player may only proceed in a single direction through the maze and accordingly if they encounter a dead end, the game is over. In a variation, the game ends when the player first encounters a credit awarding object which may be the shamrock or the pot of gold 1130.

A token 110A represents the position of the player in the maze. In this game, the player is allowed to release the object as often as desired in order to reassess their position (provided they have not reached an end point). FIG. 11B shows a player as represented by the hand 1140A moving object. As the player moves the token 1110C through the maze a line 1160 representing the direction in which the player is moved is shown on the screen to represent the players pathway. It will be appreciated that this method allows the player to move swiftly and intuitively through the maze. For example, a player is not required to make a new direction selection each time the player wishes to turn a corner of the maze.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in any country.

1. A gaming system comprising:
a touch screen display;
a display controller arranged to control the touch screen display to display at least one player moveable object to a player of a game; and
a contact monitor arranged to monitor an output of the touch screen display to determine that a contact has been detected by the touch screen display at a first position corresponding to the current location of a moveable object and that the contact has been maintained with the touch screen display while moving to a second position,
the display controller further configured to control the display to display the moveable object at a new location derived from the second position.

2. A gaming system as claimed in claim 1, wherein the display controller controls the display to display the moveable object moving to the new location.

3. A gaming system as claimed in claim 1, wherein a set of possible locations is defined for the moveable object, and the display controller derives the new location by determining which of the set of possible locations is nearest to the second position.

4. A gaming system as claimed in claim 1, comprising a game outcome determiner arranged to determine a game outcome based on the new location of the moveable object.

5. A gaming system as claimed in claim 4, comprising a game play mechanism operable by the player to place a wager, and wherein the game outcome determiner determines a game outcome based partly on the wager.

6. A gaming system as claimed in claim 1, wherein at least one moveable object is an indicator.

7. A gaming system as claimed in claim 6, wherein the new location of the indicator indicates a bet amount.

8. A gaming system as claimed in claim 6, wherein the new location of the indicator indicates a number of lines to be wagered on.

9. A gaming system as claimed in claim 6, wherein the new location of the indicator indicates a number of ways to be wagered on.

10. A gaming system as claimed in claim 1, wherein there are a plurality of possible new locations, and the display controller moves the at least one moveable object to one of the possible new locations.

11. A gaming system as claimed in claim 1, wherein there are a plurality of moveable objects.

12. A gaming system as claimed in claim 11 when dependent on claim 4, wherein the game outcome determiner is arranged to determine a game outcome based on the new location of the moveable objects only after a specified number of the plurality of the moveable objects have moved to respective ones of a plurality of new locations.

13. A gaming system as claimed in claim 4, wherein the game outcome determiner is arranged to determine that a condition has been met before determining a game outcome.

14. A gaming system as claimed in claim 13, wherein the moveable object is a token indicating a position in a maze and a condition is a player reaching a specified position in the maze.

15. A gaming system as claimed in claim 14 wherein a player is allowed to release the moveable object as many times as desired until the condition is met.

16. A method of gaming comprising:
displaying at least one moveable object on a touch screen display;
monitoring an output of the touch screen display to determine that a contact has been detected by the touch screen display at a first position corresponding to the current location of the moveable object and that the contact is maintained with the touch screen display while moving to a second position; and
displaying the moveable object at a new location derived from the second position.

17. A method as claimed in claim 16, comprising controlling the display to display the moveable object moving to the new location.

18. A method as claimed in claim 16, wherein a set of possible locations is defined for the moveable object, and deriving the new location comprises determining which of the set of possible locations is nearest to the second position.

19. A method as claimed in claim 16, comprising determining a game outcome based on the new location of the moveable object.

20. A method as claimed in claim 19, comprising determining the game based partly on a wager made by the player.

21. A method as claimed in claim 16, wherein at least one moveable object is an indicator.

22. A method as claimed in claim 21, wherein the new location of the indicator indicates a bet amount.

23. A method as claimed in claim 21, wherein the new location of the indicator indicates a number of lines to be wagered on.

24. A method as claimed in claim 21, wherein the new location of the indicator indicates a number of ways to be wagered on.

25. A method as claimed in claim 16, wherein there are a plurality of possible new locations, and the display controller moves the at least one moveable object to one of the possible new locations.

26. A method as claimed in claim 16, wherein there are a plurality of moveable objects.

27. A method as claimed in claim 26, comprising determining a game outcome based on the new location of the moveable object, wherein the game outcome determiner is arranged to determine a game outcome based on the new location of the moveable objects only after a specified number of the plurality of the moveable objects have moved to respective ones of a plurality of new locations.

28. A method as claimed in claim 18, wherein the game outcome determiner is arranged to determine that a condition has been met before determining a game outcome.

29. A method as claimed in claim 28, wherein the moveable object is a token indicating a position in a maze and a condition is a player reaching a specified position in the maze.

30. A method as claimed in claim 29 wherein a player is allowed to release the moveable object as many times as desired until the condition is met.

31. A method of moving a moveable object in a gaming system:
contacting a touch screen display at a first position corresponding to the current location of the moveable object; and
maintaining contact to a second position corresponding to a desired new location of the moveable object.

32. Computer program code which when executed causes a computer to carry out the steps of:
displaying at least one moveable object on a touch screen display;
monitoring an output of the touch screen display to determine that a contact has been detected by the touch screen display at a first position corresponding to the current location of the moveable object and that the contact is maintained with the touch screen display while moving to a second position; and
displaying the moveable object at a new location derived from the second position.
